(19) United States
(12) Patent Application Publication
(10) Pub. No.: US 2026/0192446 A1
(43) Pub. Date: Jul. 9, 2026

(54) System and Method Suitable for Tuning a Pre-Trained Diffusion Policy of a Robot

(71) Applicant: Mitsubishi Electric Research Laboratories, Inc., Cambridge, MA (US)

(72) Inventors: Devesh Jha, Cambridge, MA (US); Yuxin Chen, Berkeley, CA (US); Diego Romeres, Boston, MA (US)

(73) Assignee: Mitsubishi Electric Research Laboratories, Inc., Cambridge, MA (US)

(21) Appl. No.: 19/013,484

(22) Filed: Jan. 8, 2025

(51) Int. Cl. B25J 9/16; G06N 3/092

(52) U.S. Cl. CPC B25J 9/163; G06N 3/092

(57) ABSTRACT

The present disclosure provides a system and a method for controlling an operation of a robot to execute a task. The method includes collecting a set of trajectories by executing a pre-trained diffusion policy of the robot and receiving a feedback label corresponding to each pair of trajectories of the set of trajectories, wherein the feedback label corresponding to each pair of trajectories indicates a preference to at least one trajectory of the corresponding pair of trajectories. The method further includes learning a reward function based on each pair of trajectories and its corresponding feedback label, and tuning the pre-trained diffusion policy based on the reward function, via reinforcement learning. The method further includes controlling, based on the tuned pre-trained diffusion policy, the operation of the robot to execute the task.

### TECHNICAL FIELD

The present disclosure relates generally to control systems, and more specifically to a system and a method suitable for tuning a pre-trained diffusion policy of a robot and controlling an operation of the robot based on the tuned pre-trained diffusion policy.

### BACKGROUND

Robots are autonomous or semi-autonomous machines designed to perform tasks ranging from simple actions, such as picking up objects, to more complex operations, like assembling parts in a manufacturing line or performing medical procedures. To enable the robots to perform the tasks, the robots are trained using a variety of methods, including demonstration-based learning.

During training of the robots, the robots are provided with data or instructions that guide them in performing specific actions under controlled conditions. For example, a robot is trained through a series of demonstrations where an expert manually performs the task, and the robot learns to mimic the expert's actions. Alternatively, the robots learn by trial and error, adjusting their behaviors based on feedback on their actions. The training of the robots allows the robots to develop a control policy which is a set of rules or algorithms that determines how the robot should act to complete the task.

However, when such trained robots are deployed in real-world settings, the robots encounter additional constraints or dynamic factors that may not have been accounted for during training. For example, a robot tasked with stacking blocks faces an undesired region or obstacle that was not present during the training, or the robot needs to modify its approach to align the blocks in a stable configuration rather than stacking the blocks in an unstable manner.

Such additional constraints or dynamic factors cause the control policy of the robot to perform poorly or sub optimally, resulting in failure of task completion or inefficient performance of the robot.

### SUMMARY

It is an object of some embodiments to tune a pre-trained diffusion policy of a robot to align the pre-trained diffusion policy with additional constraints or preferences related to a task of the robot. The additional constraints, for example, includes avoiding undesired regions while performing the task. The preferences, for example, includes aligning blocks rather than unstable stacking during a block stacking task. According to an embedment, the pre-trained trained diffusion policy is a diffusion policy determined in advance via imitation learning from human demonstrations.

Embodiments of the present disclosure provide a controller for tuning a pre-trained diffusion policy of the robot according to the additional preferences/constraints and controlling an operation of the robot based on the tuned pre-trained diffusion policy. The robot is communicatively coupled to the controller. In some embodiments, the controller is integrated into the robot. The controller is configured to control the operation of the robot to execute the task. The controller includes a processor, a memory, and a user interface. The user interface includes a joystick, a remote controller, a virtual reality controller, and the like. In some embodiments, the user interface includes a display or a touch screen via which a user inputs data to the robot.

Further, the memory includes the pre-trained trained diffusion policy and a policy tuner. The processor is configured to execute the pre-trained trained diffusion policy to perform the task.

The processor is configured to collect a set of trajectories by executing the pre-trained diffusion policy. The pre-trained diffusion policy is executed in a simulated environment or in real world. When the pre-trained diffusion policy is executed, the robot follows a trajectory to perform the task. The trajectory is a sequence of action-state pairs of the robot. Such trajectories are collected.

Further, the processor is configured to obtain different pairs of trajectories by randomly sampling the set of trajectories. The different pairs of trajectories include a first pair of trajectories (Tₐ, T_{b}), a second pair of trajectories (T_{c}, T_{d}), . . . , n^{th} pair of trajectories (Tₘ, Tₙ).

For instance, the first pair of trajectories (Tₐ, T_{b}) includes a first trajectory Tₐ and a second trajectory T_{b}. For the first pair of trajectories (Tₐ, T_{b}), the user inputs a feedback label ‘y’, via the user interface. The feedback label ‘y’ indicates a preference to the first trajectory Tₐ, a preference to the second trajectory T_{b}, or an equal preference to both the first trajectory Tₐ and the second trajectory T_{b}.

For example, in an embodiment, the user inputs, via the user interface, the feedback label y ∈{−1,0,1}, where the feedback label ‘0’ means the first trajectory Tₐ is preferred, the feedback label ‘1’ means the second trajectory T_{b} is preferred, and −1 means both the first trajectory Tₐ and the second trajectory T_{b} are equally preferable.

The processor is further configured to determine a reward function based on each pair of trajectories and its corresponding feedback label. The processor is further configured to execute the policy tuner to tune the pre-trained diffusion policy based on the reward function, via reinforcement learning. The reinforcement learning is a learning framework that handles sequential decision-making problems, wherein the robot learns a policy to optimize a long-term reward by interacting with an environment in which the robot is operating.

The processor is further configured to control the operation of the robot based on the tuned pre-trained diffusion policy. Since the operation of the robot is controlled based on the tuned pre-trained diffusion policy that is aligned with the preferences, the robot performs the task according to the preferences without degradation in the performance of the robot.

Accordingly, one embodiment discloses a controller for controlling an operation of a robot to execute a task, comprising: a processor; and a memory having instructions stored thereon that, when executed by the processor, cause the controller to: collect a set of trajectories by executing a pre-trained diffusion policy of the robot; receive a feedback label corresponding to each pair of trajectories of the set of trajectories, wherein the feedback label corresponding to each pair of trajectories indicates a preference to at least one trajectory of the corresponding pair of trajectories; learn a reward function based on each pair of trajectories and its corresponding feedback label; finetune the pre-trained diffusion policy based on the reward function, via reinforcement learning; and control, based on the finetuned diffusion policy, the operation of the robot to execute the task.

Accordingly, another embodiment discloses a method for controlling an operation of a robot to execute a task. The method comprises collecting a set of trajectories by executing a pre-trained diffusion policy of the robot; receiving a feedback label corresponding to each pair of trajectories of the set of trajectories, wherein the feedback label corresponding to each pair of trajectories indicates a preference to at least one trajectory of the corresponding pair of trajectories; learning a reward function based on each pair of trajectories and its corresponding feedback label; finetuning the pre-trained diffusion policy based on the reward function, via reinforcement learning; and controlling, based on the finetuned diffusion policy, the operation of the robot to execute the task.

Accordingly, yet another embodiment discloses a non-transitory computer-readable storage medium embodied thereon a program executable by a processor for performing a method for controlling an operation of a robot to execute a task. The method comprises collecting a set of trajectories by executing a pre-trained diffusion policy of the robot; receiving a feedback label corresponding to each pair of trajectories of the set of trajectories, wherein the feedback label corresponding to each pair of trajectories indicates a preference to at least one trajectory of the corresponding pair of trajectories; learning a reward function based on each pair of trajectories and its corresponding feedback label; finetuning the pre-trained diffusion policy based on the reward function, via reinforcement learning; and controlling, based on the finetuned diffusion policy, the operation of the robot to execute the task.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A illustrates a system for controlling an operation of a robot to execute a task, according to an embodiment of the present disclosure.

FIG. 1B illustrates imitation learning, according to some example embodiments of the present disclosure.

FIG. 1C shows a block diagram for tuning a pre-trained diffusion policy to align the pre-trained diffusion policy with preferences, according to some embodiments of the present disclosure.

FIG. 2A illustrates a feedback label, according to some embodiments of the present disclosure.

FIG. 2B illustrates receiving the feedback label for each pair of the different pairs of trajectories, according to some embodiments of the present disclosure.

FIG. 3 is a diagram illustrating a general idea of reinforcement learning, according to the embodiments of the present disclosure.

FIG. 4A illustrates a task of pushing an object, according to an embodiments of the present disclosure.

FIG. 4B illustrates a set of trajectories collected by executing the pre-trained diffusion policy, according to some embodiments of the present disclosure.

FIG. 4C illustrates controlling the operation of the robot based on the tuned pre-trained diffusion policy, according to an embodiment of the present disclosure.

FIG. 5 is a schematic illustrating by non-limiting example a computing apparatus for implementing the methods and the systems of the present disclosure.

FIG. 6 shows a schematic for training of a diffusion policy using demonstration data, according to some embodiments of the present disclosure.

FIG. 7 shows a schematic for training the diffusion policy as a denoising diffusion policy model, according to some embodiments of the disclosure

FIG. 8 shows a schematic for a Markov decision process (MDP) formulation of fine-tuning process using a reward function, according to some embodiments of the present disclosure.

FIG. 9 shows a schematic for fine-tuning of the diffusion policy, according to some embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

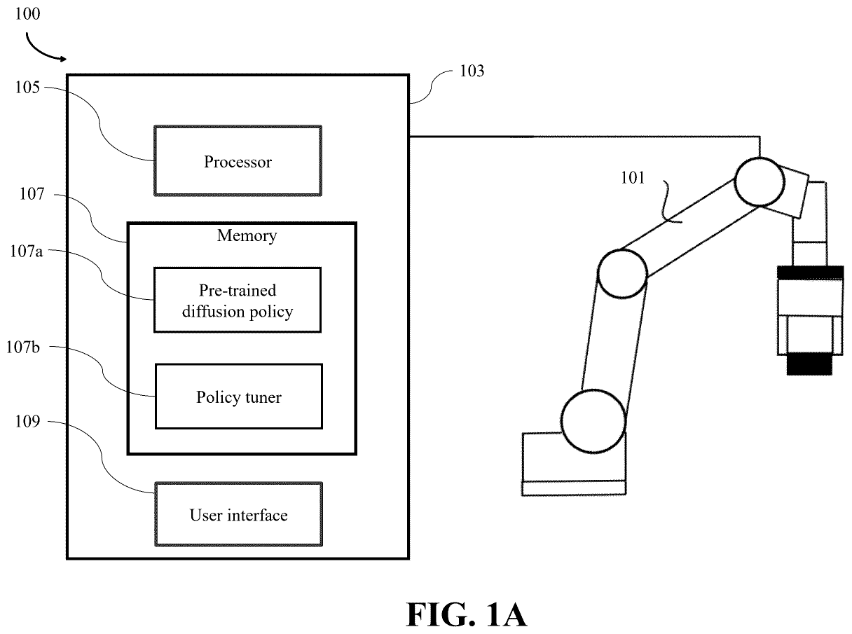

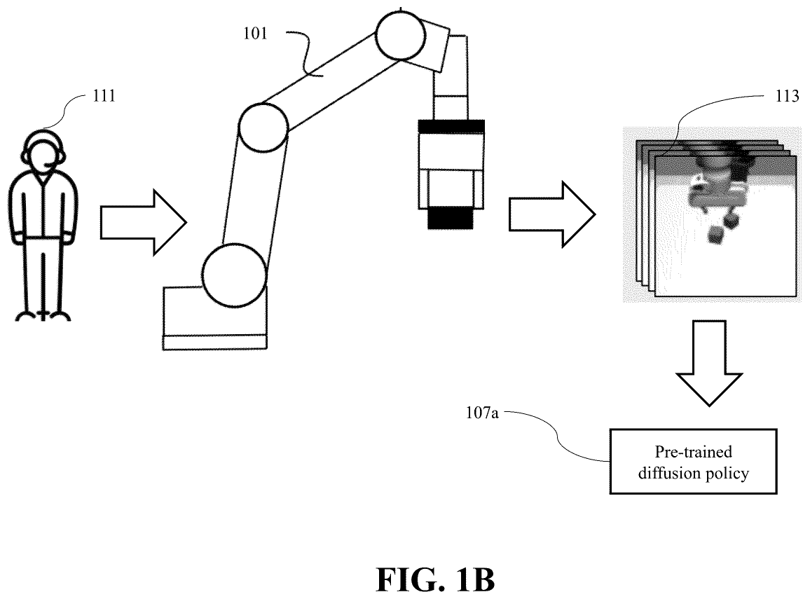

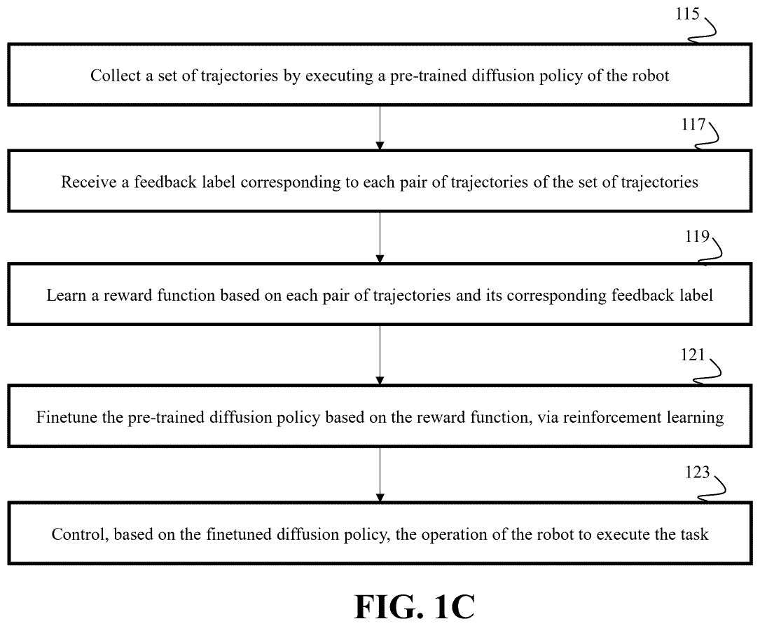

FIG. 1A illustrates a system 100 for controlling an operation of a robot 101 to execute a task, according to an embodiment of the present disclosure. The robot 101 includes a robotic arm or a robotic manipulator which is configured to execute the task. The task includes, for example, one or a combination of pushing an object to a target location, stacking of objects, and aligning of the objects. For example, the robot 101 is a placement robot and the task of the robot 101 is to place different objects within specified positions in a box or a delivery carton. In another example, the robot 101 is an assembly line robot and the task of the robot 101 is to lift and move the objects within an industrial or manufacturing unit, such as between different machines, for transporting the objects, removing defected manufactured units, and the like. In general, a task has a start condition and an end condition, referred to as a task goal. The task is considered complete once the task goal has been achieved.

The robot 101 is communicatively coupled to a controller 103. In some embodiments, the controller 103 is integrated into the robot 101. The controller 103 is configured to control the operation of the robot 101 to execute the task. The controller 103 includes a processor 105, a memory 107, and a user interface 109. The processor 105 may be a single core processor, a multi-core processor, a computing cluster, or any number of other configurations. The memory 107 may include random access memory (RAM), read only memory (ROM), flash memory, or any other suitable memory systems. Additionally, in some embodiments, the memory 107 may be implemented using a hard drive, an optical drive, a thumb drive, an array of drives, or any combinations thereof. The user interface 109 includes a joystick, a remote controller, a virtual reality controller, and the like. In some embodiments, the user interface 109 includes a display or a touch screen via which a user inputs data to the robot 101.

Further, the memory 107 includes a pre-trained trained diffusion policy 107a and a policy tuner 107b. The processor 105 is configured to execute the pre-trained trained diffusion policy 107a to perform the task. The pre-trained trained diffusion policy 107a is a diffusion policy determined in advance via imitation learning from human demonstrations.

FIG. 1B illustrates the imitation learning, according to some example embodiments of the present disclosure. In the imitation learning, a user 111 acting as a robot operator operates the robot 101 to perform the task. For instance, the user 111 uses the user interface 109 to provide action inputs to the robot 101 to change actions of the robot 101. The action inputs control the robot's 101 movements, such as arm positions, gripper actions, an orientation of joints, or an end-effector movement.

In parallel with the action inputs, sensors on the robot 101 (such as encoders, cameras, or force/torque sensors) collect sensor data corresponding to the robot's actions. The collected sensor data includes a state of the robot 101, e.g., joint angles of the robot 101, velocities of the robot 101, 3D positions of the robot 101, and the like.

The robot 101 logs the action inputs and the corresponding sensor data over time (often in real-time). The sensor data represents the state of the robot 101 at each moment, while the action inputs represent the actions taken by the user 111. These pairs of data (state-action pairs) form training dataset 113 for the imitation learning.

Some embodiments of the current disclosure are based on the realization that generative models have highlighted their remarkable ability to synthesize complex, high-dimensional distributions, offering new opportunities for enhancing policy learning. Among the generative models, diffusion models, a type of generative model that gradually transform random noise into a data sample, have been applied in the imitation learning for robotics. These models, referred to as diffusion policies. To this end, based on the formed training dataset 113, the pre-trained diffusion policy 107a is determined.

However, during real-world deployment of the robot 101 with the pre-trained diffusion policy 107a, the robot 101 encounters additional constraints or preferences that may not have been accounted for during the training. The additional constraints, for example, include avoiding undesired regions while performing the task. The preferences, for example, include aligning blocks rather than unstable stacking during a block stacking task. Such additional constraints and/or preferences cause the pre-trained diffusion policy 107a of the robot 101 to perform poorly or sub optimally, resulting in failure of task completion or inefficient performance of the robot 101.

Some embodiments are based on the realization that the pre-trained diffusion policy 107a can be tuned to align the pre-trained diffusion policy 107a with the preferences/constraints. To this end, some embodiments provide the policy tuner 107b configured to tune the pre-trained diffusion policy 107a to align the pre-trained diffusion policy 107a with the preferences. The processor 105 is configured to execute the policy tuner 107b to tune the pre-trained diffusion policy 107a.

FIG. 1C shows a block diagram for tuning the pre-trained diffusion policy 107a to align the pre-trained diffusion policy 107a with the preferences, according to some embodiments of the present disclosure. At block 115, the processor 105 is configured to collect a set of trajectories by executing the pre-trained diffusion policy 107a. The pre-trained diffusion policy 107a is executed in a simulated environment or in real world. When the pre-trained diffusion policy 107a is executed, the robot 101 follows a trajectory to perform the task. The trajectory is a sequence of action-state pairs of the robot 101. Such trajectories are collected.

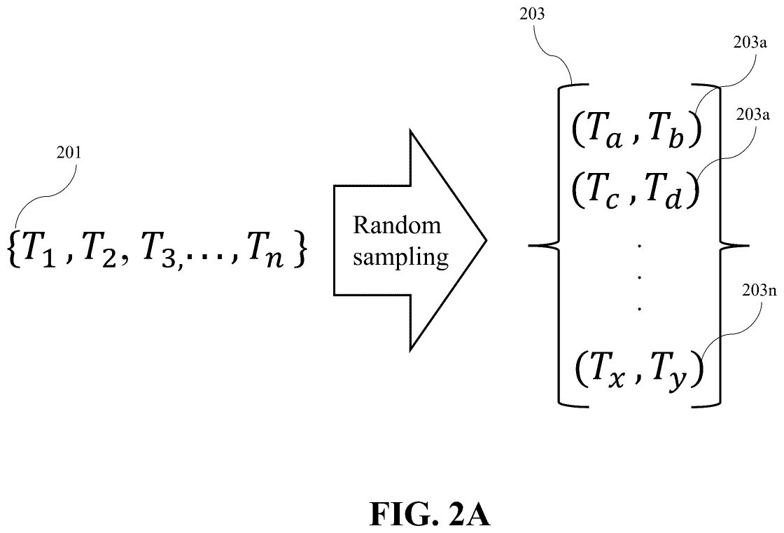

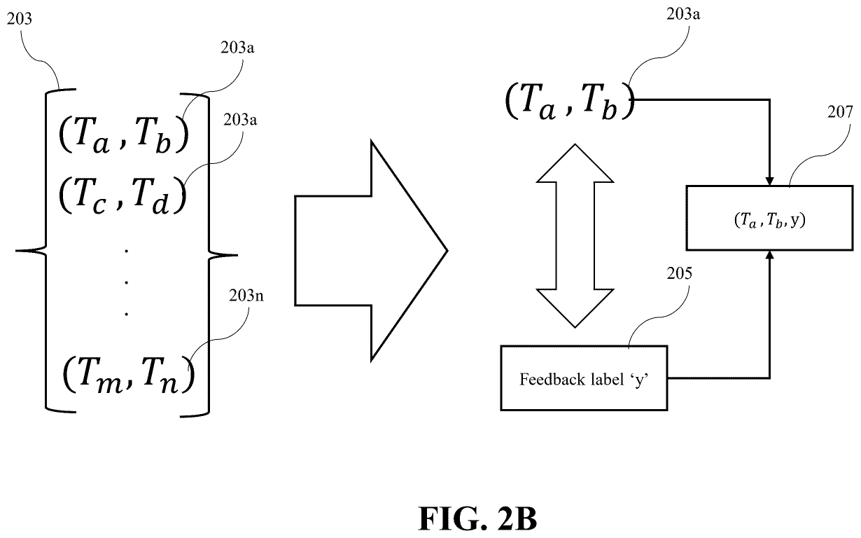

At block 117, the processor 105 is configured to receive a feedback label corresponding to each pair of trajectories of the set of trajectories. The feedback label corresponding to each pair of trajectories indicates a preference to at least one trajectory of the corresponding pair of trajectories. The feedback label is explained in detail in FIG. 2.

At block 119, the processor 105 is configured to learn a reward function based on each pair of trajectories and its corresponding feedback label.

At block 121, the processor 105 is configured to execute the policy tuner 107b to finetune the pre-trained diffusion policy 107a based on the reward function, via reinforcement learning. The reinforcement learning is a learning framework that handles sequential decision-making problems, wherein the robot 101 learns a policy to optimize a long-term reward by interacting with an environment in which the robot 101 is operating.

At block 123, the processor 105 is configured to control the operation of the robot 101 based on the finetuned diffusion policy. Since the operation of the robot 101 is controlled based on the finetuned diffusion policy that is aligned with the preferences, the robot 101 performs the task according to the preferences without degradation in the performance of the robot 101.

FIG. 2A illustrates the feedback label, according to some embodiments of the present disclosure. As explained above, the processor 105 collects a set of trajectories {T₁, T₂, T₃, . . . , Tₙ}201 by executing the pre-trained diffusion policy 107a. Further, the processor 105 is configured to obtain different pairs of trajectories 203 by randomly sampling the set of trajectories {T₁, T₂, T₃, . . . , Tₙ}201. The different pairs of trajectories 203 include a first pair of trajectories (Tₐ, T_{b}) 203a, a second pair of trajectories (T_{c}, T_{d}) 203b, . . . , n^{th} pair of trajectories (Tₘ, Tₙ) 203n.

FIG. 2B illustrates receiving the feedback label for each pair of the different pairs of trajectories 203, according to some embodiments of the present disclosure. For instance, the first pair of trajectories (Tₐ, T_{b}) 203a includes a first trajectory Tₐ and a second trajectory T_{b}. For the first pair of trajectories (Tₐ, T_{b}) 203a, the user 111 inputs a feedback label ‘y’ 205, via the user interface 109. The feedback label ‘y’ 205 indicates a preference to the first trajectory Tₐ, a preference to the second trajectory T_{b}, or an equal preference to both the first trajectory Tₐ and the second trajectory T_{b}.

For example, in an embodiment, the user 111 inputs, via the user interface 109, the feedback label y ∈{−1,0, 1}205, where the feedback label ‘0’ means the first trajectory Tₐ is preferred, the feedback label ‘1’ means the second trajectory T_{b} is preferred, and −1 means both the first trajectory Tₐ and the second trajectory T_{b} are equally preferable.

The first pair of trajectories (Tₐ, T_{b}) 203a and its corresponding feedback label ‘y’ 205 forms tuning data (Tₐ, T_{b}, y). Likewise, such tuning data is formed for other pair of trajectories by receiving a feedback label for each of the second pair of trajectories (T_{c}, T_{d}) 203b, . . . , n^{th} pair of trajectories (Tₘ, Tₙ) 203n.

In some embodiments, the feedback label is used to train a machine learning model that is configured to predict a scalar reward for a new trajectory of the robot 101. Additionally, in some embodiments, each pair of trajectories and its corresponding feedback label are used to determine the reward function.

Further, the pre-trained diffusion policy 107a is tuned based on the reward function, via the reinforcement learning, as described below.

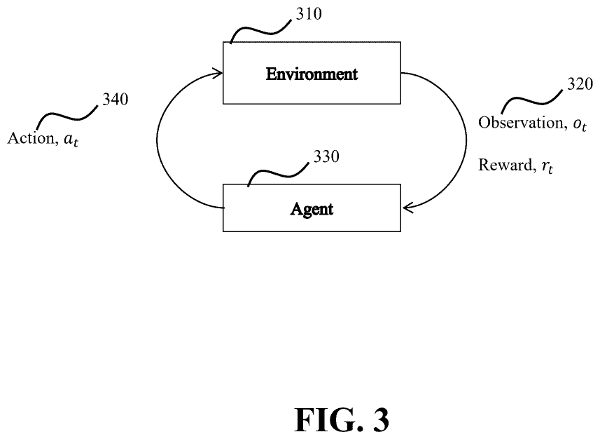

FIG. 3 is a diagram illustrating a general idea of the reinforcement learning, according to the embodiments of the present disclosure. The reinforcement learning is a learning framework that handles sequential decision-making problems, wherein an ‘agent’ 330 or decision maker learns a policy to optimize a long-term reward by interacting with the (unknown) environment 310. At each step, a reinforcement learning agent obtains evaluative feedback (called reward or cost) 350 about the performance of its action 340 along with an observation of the environment, allowing it to improve (maximize or minimize) performance of subsequent actions.

In order to tune the pre-trained diffusion policy 107a with the reinforcement learning, a Markov decision process model for the pre-trained diffusion policy 107a is formulated.

### Markov Decision Process and Reinforcement Learning

A Markov Decision Process (MDP) is defined by a tuple [symbol] =( [symbol] , [symbol] , r, p, ρ₀), where [symbol] ∈ [symbol] ^{S} represents a state space, [symbol] ∈ [symbol] ^{A} is an action space, r: [symbol] × [symbol] [symbol] [symbol] is the reward function, p: [symbol] × [symbol] × [symbol] [symbol] [0, ∞) defines a probability density of a next state sₜ₊₁ ∈ [symbol] , given a current state sₜ ∈ [symbol] and action aₜ ∈ [symbol] . An initial state distribution is denoted by ρ₀. At each time step t, the robot 101 observes the current state sₜ, selects an action aₜ, receives a reward r(sₜ, aₜ), and transitions to the next state sₜ₊₁ following a transition probability p(sₜ₊₁|sₜ, aₜ).

With a given policy π_{θ}(a|s) for the robot 101, parameterized by θ, and an initial state s₀ ~ρ₀, the robot 101 generates a trajectory, which is a sequence of state-action pairs, ξ={(s₀, a₀), (s₁, a₁), . . . , (s_{T}, a_{T})}. An objective of the reinforcement learning (RL) is to maximize an expected cumulative reward over over each trajectory of each pair of trajectories sampled from a policy ξ~p(ξ|π_{θ}):

$${𝒥}_{RL} ( {π}_{θ} ) = {𝔼}_{ξ} [ {\sum }_{t = 0}^{T} r ( {s}_{t} , {a}_{t} ) ] . \qquad ( 1 )$$

In some embodiments, policy gradient algorithms are used to train the policy in RL. The policy gradient algorithms update the parameters θ of the policy in a direction of an objective gradient:

$${∇}_{θ} {𝒥}_{RL} ( {π}_{θ} ) = {𝔼}_{ξ} [ {\sum }_{t = 0}^{T} {∇}_{θ} log {π}_{θ} ( {a}_{t} \vert {s}_{t} ) {Q}^{{π}_{θ}} ( {s}_{t} , {a}_{t} ) ] , \qquad ( 2 )$$

where Q^{π}^{_{θ}} is a state-action value function (also known as Q-function) estimator.

### Diffusion Model and Diffusion Policy

Denoising diffusion probabilistic models (DDPM) are used to model a distribution of a dataset of samples, x⁰, conditioned on some context c, represented as x⁰ ~p(x⁰|c), where x⁰ ∈ [symbol] ⁿ. This distribution is learned by modeling a reverse denoising process of a Markovian forward process q(x^{k}|x^{k-1}), which progressively adds Gaussian noise to the dataset of samples over time.

The reverse denoising process p(x^{k-1} |x^{k}, c) is designed to recover original, noise-free sample x⁰ from an initial Gaussian noise x^{K} ~ [symbol] (0, I) through K iterations of denoising. The reverse denoising process generates a series of intermediate samples with progressively less noise, denoted as {x^{K}, x^{K-1}, . . . , x⁰}. Specifically, the reverse denoising process is defined as

$$p ( {x}^{k - 1} \vert {x}^{k} , c ) = 𝒩 ( {x}^{k - 1} ; {μ}_{θ} ( {x}^{k} , c , k ) , {σ}_{k}^{2} I ) , \qquad ( 3 )$$

where μ_{θ} is a neural network parameterized by θ that predicts the added Gaussian noise at each iteration, and σₖ represents a step-dependent variance governed by a variance schedule.

The neural network μ_{θ} is trained with following objective:

$${ℒ}_{DM} ( θ ) = {𝔼}_{( {x}^{0} , c , {x}^{k} , k )} {‖ \overline{μ} ( {x}^{0} , k ) - {μ}_{θ} ( {x}^{k} , c , k ) ‖}^{2} , \qquad ( 4 )$$

where μ̅ is a posterior mean of the Markovian forward process.

The pre-trained diffusion policy 107a is a diffusion policy (DP) that models visuomotor robot policies (i.e., the motor policies could take vision observation as input and output motor torques) using the DDPMs, incorporating two key modifications: 1) Predicted data sample represents an action sequence Aₜ of length Tₐ, defined as an action execution horizon; 2) Latest Tₛ steps of state sequence Sₜ at z time step t is used as conditional context for the reverse denoising process.

Given the state sequence Sₜ, conditional distribution of Aₜ is recovered through K steps of the reverse denoising process, using a modified version of Eq. 3:

$$p ( {A}_{t}^{k - 1} \vert {A}_{t}^{k} , {S}_{t} ) = 𝒩 ( {A}_{t}^{k - 1} ; {μ}_{θ} ( {A}_{t}^{k} , {S}_{t} , k ) , {σ}_{k}^{2} I ) . \qquad ( 5 )$$

The neural network μ_{θ} is trained with a modified [symbol] _{DM}, defined as:

$${ℒ}_{DP} ( θ ) = {𝔼}_{( {A}_{t} , S , {A}_{t}^{k} , k )} {‖ \overline{μ} ( {A}_{t} , k ) - {μ}_{θ} ( {A}_{t}^{k} , S , k ) ‖}^{2} , \qquad ( 6 )$$

where

$${A}_{t}^{0}$$

is shorthand for Aₜ, representing a final action sequence for execution.

### Preference-based Reward Learning

The trajectory is defined as a sequence of states σ={s₁, s₂, . . . , s_{H}}, where H≥1. In some embodiments, H is considered as H=1, meaning each trajectory includes a single state. For a pair of trajectories (σ⁰, σ¹), the user 111 provides the feedback label y ∈ {-1,0,1}, indicating which trajectory is preferred, where 0 means trajectory σ⁰ is preferred, 1 means trajectory σ¹ is preferred, and −1 means both trajectories are equally preferable.

Using Bradley-Terry model, which assumes a probability of preferring one trajectory over another is exponentially dependent on a sum of an underlying reward function over the trajectory, a preference probability for the pair of trajectories, given a reward function estimator \hat{r}_{ψ}, can be expressed as

$${p}_{ψ} [ {σ}^{1} \text{?} {σ}^{0} ] = \frac{exp ( {\sum }_{h = 1}^{H} {\hat{r}}_{ψ} ( {σ}^{1} ) )}{{\sum }_{i ∈ \{ 0 , 1 \}} exp ( {\sum }_{h = 1}^{H} {\hat{r}}_{ψ} ( {σ}^{i} ) )} , \qquad ( 7 )$$

where σⁱ [symbol] σ^{j} denotes trajectory σⁱ being preferred over σ^{j}. Eq. 7 simplifies to

$${p}_{ψ} [ {s}^{1} \text{?} {s}^{0} ] = \frac{exp ( {\hat{r}}_{ψ} ( {s}^{1} ) )}{{\sum }_{i ∈ \{ 0 , 1 \}} exp ( {\hat{r}}_{ψ} ( {s}^{i} ) )} . \qquad ( 8 )$$

Given a dataset of preference labels

$$D = \{ ( {σ}_{i}^{0} , {σ}_{i}^{1} , {y}_{i} ) \} ,$$

the reward function estimator \hat{r}_{ψ} can be optimized by minimizing following loss:

$${ℒ}_{RWD} ( ψ ) = - {𝔼}_{( {σ}^{0} , {σ}^{1} , y )} [ 1 \{ y = ( {σ}^{0} \text{?} {σ}^{1} ) \} log {p}_{ψ} [ {σ}^{0} \text{?} {σ}^{1} ] + 1 \{ y = ( {σ}^{1} \text{?} {σ}^{0} ) \} log {p}_{ψ} [ {σ}^{1} \text{?} {σ}^{0} ] ] , \qquad ( 9 )$$

where 1{·}equals to 1 if statement inside is true, and equals to 0 otherwise.

At any time step t, an action sequence Aₜ={aₜ, aₜ₊₁, . . . , a_{t+I}_{ₐ}₋₁} is generated using the diffusion policy conditioned on the state sequence Sₜ={s_{t-T}_{ₛ}₊₁, s_{t-T}_{ₛ}₊₂, . . . , sₜ}. Consequently, the reward function is expressed as a function of a state-action sequence pair (Sₜ, Aₜ) by

$${r}_{ψ} ( {S}_{t} , {A}_{t} ) = {\sum }_{j = 1}^{{T}_{a}} {\hat{r}}_{ψ} ( {s}_{t + j} ) , \qquad ( 10 )$$

where each future state sₜ₊ⱼ is obtained by rolling out the action sequence Aₜ starting from the current state sₜ. Specifically, the future state sₜ₊ⱼ is sampled according to the transition probability sₜ₊ⱼ ~p(sₜ₊ⱼp(sₜ₊ⱼ|sₜ₊ⱼ₋₁, aₜ₊ⱼ₋₁).

### RL-Based Fine-Tuning

To tune the pre-trained control policy 107a based on the reward function (10), the processor 105 is configured to tune the pre-trained diffusion policy

$${p}_{θ} ( {A}_{t}^{0 : K} \vert {S}_{t} )$$

107a with the aforementioned reward function r_{ψ}(Sₜ,Aₜ) (10) by maximizing a denoising diffusion objective function:

$${𝒥}_{DDRL} ( θ ) = {𝔼}_{( {S}_{t} , {A}_{t} )} [ {r}_{ψ} ( {S}_{t} , {A}_{t} ) ] , \qquad ( 11 )$$

where Sₜ is obtained from roll-outs starting with an initial state sequence with padding S₀={s₀, . . . , s₀}, where s₀ ~ρ₀ follows the initial state distribution. The action sequence Aₜ is sampled through the pre-trained diffusion policy 107a

$${A}_{t} ∼ {p}_{θ} ( {A}_{t}^{0 : K} \vert {S}_{t} ) .$$

In some embodiments, to tune the pre-trained control policy 107a based on the reward function, the processor 105 is further configured to update parameters of the pre-trained control policy 107a in a direction of a gradient of the denoising diffusion objective function (11). For instance, according to some embodiments, the reverse denoising process of the DDPMs is represented as a multi-step MDP, where a log-likelihood is obtained via Monte-Carlo sampling. Specifically, the diffusion policy MDP [symbol] _{DP} is defined as

$$a . {\tilde{s}}_{τ} {=}^{Δ} ( {S}_{t} , k , {A}_{t}^{k} ) , \qquad ( 12 )$$

$$b . {\tilde{a}}_{τ} {=}^{Δ} {A}_{t}^{k - 1} , \qquad ( 13 )$$

$$c . π ( {\tilde{a}}_{τ} \vert {\tilde{s}}_{τ} ) {=}^{Δ} {p}_{θ} ( {A}_{t}^{k - 1} \vert {A}_{t}^{k} , {S}_{t} ) , \qquad ( 14 )$$

$$d . {ρ}_{0} ( {\tilde{s}}_{0} ) {=}^{Δ} ( p ( {S}_{t} ) , {δ}_{K} , 𝒩 ( 0 , I ) ) , \qquad ( 15 )$$

$$e . p ( {\tilde{s}}_{τ + 1} \vert {\tilde{s}}_{τ} , {\tilde{a}}_{τ} ) {=}^{Δ} ( {δ}_{{S}_{t}} , {δ}_{k - 1} , {δ}_{{A}_{t}^{k - 1}} ) , \qquad ( 16 )$$

$$f . r ( {\tilde{s}}_{τ} , {\tilde{a}}_{τ} ) {=}^{Δ} \{ \begin{matrix}{r}_{ψ} ( {A}_{t} , {S}_{t} ) & if τ = 0 \\ 0 & otherwise\end{matrix} . \qquad ( 17 )$$

Here, δ_{y} represents Dirac delta distribution, which has non-zero density only at y. The trajectories in the diffusion policy MDP [symbol] _{DP} includes K time steps, after which a state transition probability p leads to a termination state τ refers to a time step in [symbol] _{DP}, k refers to a denoising step in the DDPM, and t refers to a time step in an original environment where the diffusion policy is applied.

Since the cumulative reward of each trajectory ξ in [symbol] _{DP} is equal to a final step reward r_{ψ}(Aₜ, Sₜ), maximizing [symbol] _{DRL} (θ) in Eq. 11 is equivalent to maximizing [symbol] _{RL} (π) in Eq. 1. Therefore, gradients with respect to parameters of the pre-trained diffusion policy 107a is determined based on Eq. 2:

$$\begin{matrix}{∇}_{θ} {𝒥}_{DDRL} = {𝔼}_{\tilde{ξ}} [ {\sum }_{τ = 0}^{K} {∇}_{θ} log {π}_{θ} ( {\tilde{a}}_{τ} \vert {\tilde{s}}_{τ} ) {Q}^{{π}_{θ}} ( {\tilde{s}}_{τ} , {\tilde{a}}_{τ} ) ] , \\ = 𝔼 [ {r}_{ψ} ( {A}_{t} , {S}_{t} ) {\sum }_{k = 1}^{K} {∇}_{θ} log {p}_{θ} ( {A}_{t}^{k - 1} \vert {A}_{t}^{k} , {S}_{t} ) ]\end{matrix} \qquad ( 18 )$$

### Kullback-Leibler Regularization

Some embodiments are based on the realization that tuning the pre-trained diffusion policy 107a solely using the reward function (10) derived from each pair of trajectories and its corresponding feedback label risks over-fitting to the reward function and degrades an ability of the pre-trained diffusion policy 107a to perform an original task/initial task learned by the pre-trained diffusion policy 107a.

Some embodiments are based on the realization that Kullback-Leibler (KL) regularization can used to prevent the over-fitting to the reward function while preserving the ability of the pre-trained diffusion policy 107a to perform the original task learned by the pre-trained diffusion policy 107a. Specifically, the processor 105 is configured to compute a regularization term based on a KL divergence between the tuned pre-trained control policy and the pre-trained control policy 107a, i.e., [symbol] = [symbol] _{KL} [p_{θ}(Aₜ|Sₜ)∥pₚᵣₑ(Aₜ|Sₜ)], and incorporate the regularization term in the denoising diffusion objective function. Therefore, the denoising diffusion objective function includes the regularization term that is based on the KL divergence between the tuned pre-trained control policy and the pre-trained control policy 107a.

In some embodiments, a weight assigned to the regularization term. Some embodiments are based on the recognition that assigning a large weight results in minimal deviation from the original task learned by the pre-trained diffusion policy 107a, and assigning a small weight cause a significant decrease in performance of the pre-trained diffusion policy 107a because the RL tends to over-fit to the reward function, forgetting the original task of the pre-trained diffusion policy. Therefore, a weight that balances a fitting of the pre-trained control policy 107a to the reward function while preserving the ability of the pre-trained diffusion policy 107a to perform the original task learned by the pre-trained diffusion policy 107a, is assigned to the regularization term.

Since obtaining a closed-form expression for p_{θ}(Aₜ|Sₜ) is challenging, an upper bound for the regularization term into the objective function is introduced

$${𝔼}_{{S}_{t}} [ 𝒞 ] \leq {𝔼}_{{S}_{t}} [ {\sum }_{k = 1}^{K} {𝔼}_{{A}_{t}^{k}} ( \overline{𝒞} ) ] , \qquad ( 19 )$$

where

$$\overline{𝒞} = {𝒟}_{KL} [ {p}_{θ} ( {A}_{t}^{k - 1} \vert {A}_{t}^{k} , {S}_{t} ) \vert \vert {p}_{pre} ( {A}_{t}^{k - 1} \vert {A}_{t}^{k} , {S}_{t} ) ] .$$

Therefore, the upper bound is included into Eq. 11 to determine a new KL regularized objective function:

$${𝒥}_{DDRL} ( θ ) = {𝔼}_{{S}_{t}} [ {𝔼}_{{A}_{t}} ( {r}_{ψ} ( {S}_{t} , {A}_{t} ) ) + α {\sum }_{k = 1}^{K} {𝔼}_{{A}_{t}^{k}} ( \overline{𝒞} ) ] , \qquad ( 20 )$$

where α≥0 is the weight of the regularization term that controls a fitting of the pre-trained control policy 107a to the reward function while preserving the ability of the pre-trained diffusion policy 107a to perform the original task learned by the pre-trained diffusion policy 107a. Similarly, the new gradient is

$${∇}_{θ} {𝒥}_{DDRL} = 𝔼 [ {r}_{ψ} ( {A}_{t} , {S}_{t} ) {\sum }_{k = 1}^{K} {∇}_{θ} log {p}_{θ} ( {A}_{t}^{k - 1} \vert {A}_{t}^{k} , {S}_{t} ) + α {\sum }_{k = 1}^{K} {∇}_{θ} {𝒟}_{KL} [ {p}_{θ} ( {A}_{t}^{k - 1} \vert {A}_{t}^{k} , {S}_{t} ) \vert \vert {p}_{pre} ( {A}_{t}^{k - 1} \vert {A}_{t}^{k} , {S}_{t} ) ] ] . \qquad ( 21 )$$

### Exemplary Embodiments

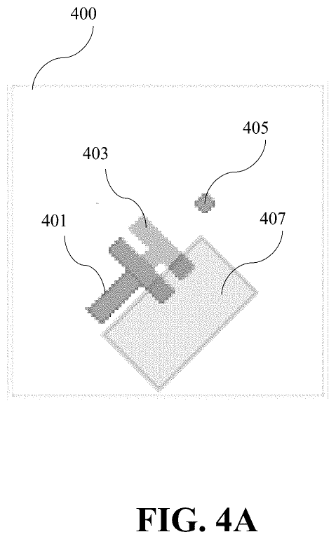

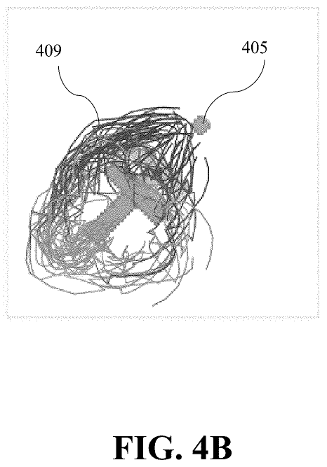

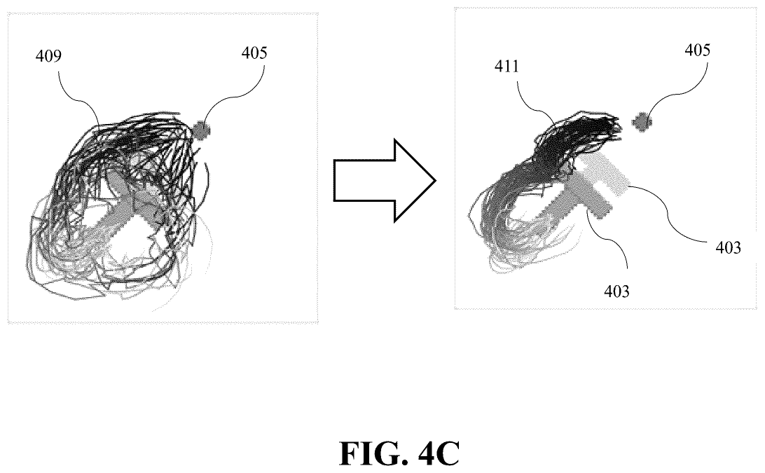

FIG. 4A illustrates a task of pushing an object 401, according to an embodiments of the present disclosure. The robot 101 is desired to perform the task of pushing the object 401 to a target location 403 in an environment 400, using a circular end-effector 405 of the robot 101. The pre-trained diffusion policy 107a is to be tuned to align the pre-trained diffusion policy 107a with an additional constraint that defines a region 407 in the environment 400 to be avoided by the circular end-effector 405 of the robot 101 while pushing the object 401 to the target location 403.

To tune the pre-trained diffusion policy 107a to align the pre-trained diffusion policy 107a with the additional constraint of avoiding the region 407, the processor 105 at first collects the set of trajectories by executing the pre-trained diffusion policy 107a. The pre-trained diffusion policy 107a is executed in the simulated environment or in the real world. When the pre-trained diffusion policy 107a is executed, the robot 101 follows a trajectory to perform the task. The trajectory is a sequence of action-state pairs of the robot 101. Such trajectories are collected.

FIG. 4B illustrates a set of trajectories 409 collected by executing the pre-trained diffusion policy 107a, according to some embodiments of the present disclosure. Further, the processor 105 is configured to obtain different pairs of trajectories by randomly sampling the set of trajectories 409.

Further, the processor 105 is configured to receive the feedback label corresponding to each pair of trajectories of the set of trajectories 409. The feedback label corresponding to each pair of trajectories indicates a preference to at least one trajectory of the corresponding pair of trajectories.

Further, the processor 105 is configured to determine the reward function based on each pair of trajectories and its corresponding feedback label. The processor 105 is further configured to execute the policy tuner 107b to tune the pre-trained diffusion policy 107a based on the reward function, via the reinforcement learning.

Further, the processor 105 is configured to control the operation of the robot 101 based on the tuned pre-trained diffusion policy. FIG. 4C illustrates controlling the operation of the robot 101 based on the tuned pre-trained diffusion policy, according to an embodiment of the present disclosure. Since the operation of the robot 101 is controlled based on the tuned pre-trained diffusion policy that is aligned with the additional constraint, the robot 101 performs the task by following trajectories 411 that do not lie in the region 407. Therefore, the circular end-effector 405 of the robot 101 pushes the object 401 to the target location 403 while avoiding the region 407.

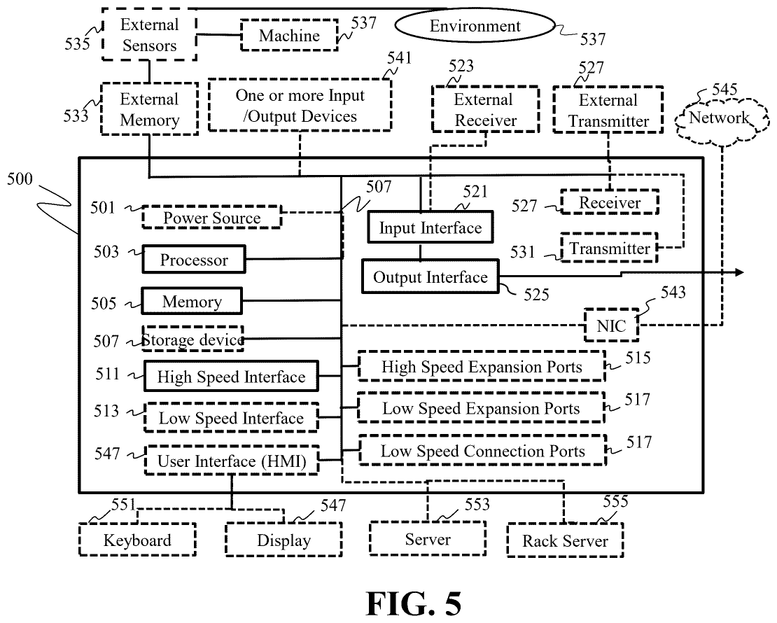

FIG. 5 is a schematic illustrating by non-limiting example a computing apparatus for implementing the methods and the systems of the present disclosure. The computing device 500 can include a power source 501, a processor 503, a memory 505, a storage device 507, all connected to a bus 509. Further, a high-speed interface 511, a low-speed interface 513, high-speed expansion ports 515 and low speed connection ports 517, can be connected to the bus 509. In addition, a low-speed expansion port 519 is in connection with the bus 509. Further, an input interface 521 can be connected via the bus 509 to an external receiver 523 and an output interface 525. A receiver 527 can be connected to an external transmitter 529 and a transmitter 531 via the bus 509. Also connected to the bus 509 can be an external memory 533, external sensors 535, machine(s) 537, and an environment 539. Further, one or more external input/output devices 541 can be connected to the bus 509. A network interface controller (NIC) 543 can be adapted to connect through the bus 509 to a network 545, wherein data or other data, among other things, can be rendered on a third-party display device, third party imaging device, and/or third-party printing device outside of the computer device 500.

The memory 505 can store instructions that are executable by the computer device 500, historical data, and any data that can be utilized by the methods and systems of the present disclosure. The memory 505 can include random access memory (RAM), read only memory (ROM), flash memory, or any other suitable memory systems. The memory 505 can be a volatile memory unit or units, and/or a non-volatile memory unit or units. The memory 505 may also be another form of computer-readable medium, such as a magnetic or optical disk.

The storage device 507 can be adapted to store supplementary data and/or software modules used by the computer device 500. For example, the storage device 507 can store historical data and other related data as mentioned above regarding the present disclosure. Additionally, or alternatively, the storage device 507 can store historical data like data as mentioned above regarding the present disclosure. The storage device 507 can include a hard drive, an optical drive, a thumb-drive, an array of drives, or any combinations thereof. Further, the storage device 507 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 503), perform one or more methods, such as those described above.

The computing device 500 can be linked through the bus 509, optionally, to a display interface or user Interface (HMI) 547 adapted to connect the computing device 500 to a display device 549 and a keyboard 551, wherein the display device 549 can include a computer monitor, camera, television, projector, or mobile device, among others. In some implementations, the computer device 500 may include a printer interface to connect to a printing device, wherein the printing device can include a liquid inkjet printer, solid ink printer, large-scale commercial printer, thermal printer, UV printer, or dye-sublimation printer, among others.

The high-speed interface 511 manages bandwidth-intensive operations for the computing device 500, while the low-speed interface 513 manages lower bandwidth-intensive operations. Such allocation of functions is an example only. In some implementations, the high-speed interface 511 can be coupled to the memory 505, the user interface (HMI) 547, and to the keyboard 551 and the display 549 (e.g., through a graphics processor or accelerator), and to the high-speed expansion ports 515, which may accept various expansion cards via the bus 509. In an implementation, the low-speed interface 513 is coupled to the storage device 507 and the low-speed expansion ports 517, via the bus 509. The low-speed expansion ports 517, which may include various communication ports (e.g., USB, Bluetooth, Ethernet, wireless Ethernet) may be coupled to the one or more input/output devices 541. The computing device 500 may be connected to a server 553 and a rack server 555. The computing device 500 may be implemented in several different forms. For example, the computing device 500 may be implemented as part of the rack server 555.

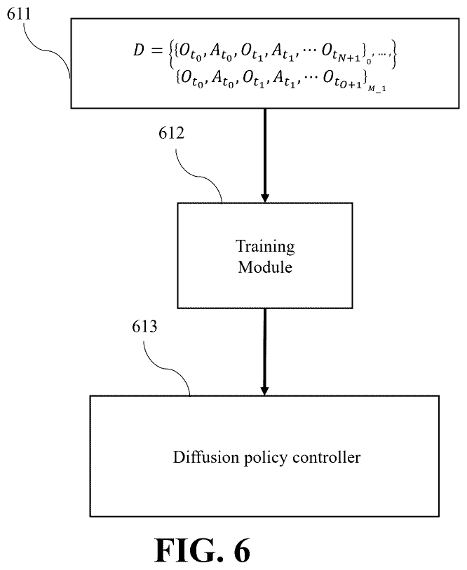

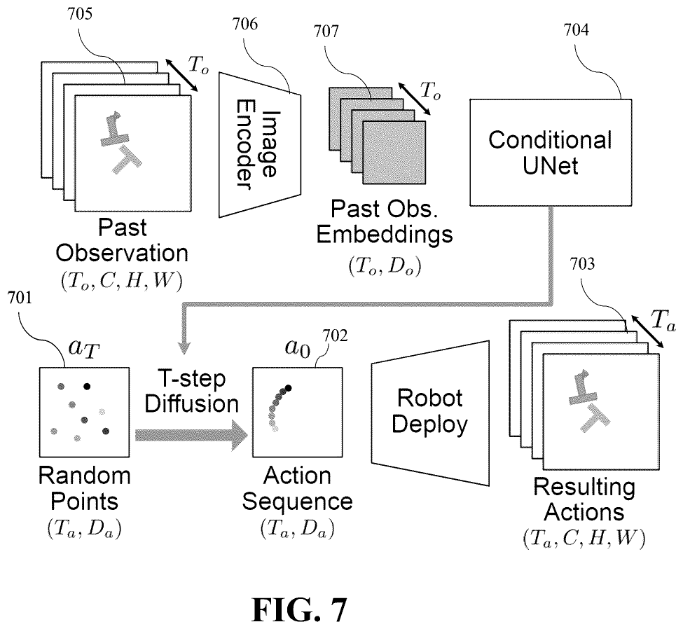

FIGS. 6 and 7 illustrate a training procedure for a diffusion policy using demonstration data, according to an embodiment of the present disclosure. The training procedure takes a dataset 611 as training data. The dataset 611 includes data from multiple demonstrations for a task. The dataset 611 is used to train a diffusion policy controller 613 using a training module 612. FIG. 7 shows a detailed description of the training procedure for the diffusion policy, according to an embodiment of the present disclosure. Training of the diffusion policies is formulated as the DDPMs. The diffusion policies are able to express complex multimodal action distributions and possess stable training behavior. The DDPMs are a class of generative model where an output generation is modeled as a denoising process. Starting from x^{K} sampled from Gaussian noise, the DDPM performs K iterations of denoising to produce a series of intermediate actions with decreasing levels of noise x^{k}, x^{k-1}, . . . , x⁰, until a desired noise-free output x° is formed. The DDPM training process starts by randomly drawing unmodified examples, x⁰, from the dataset 611. For each sample, a denoising iterations k is randomly selected along with sampling an appropriate variance ϵ^{k} with appropriate variance for iteration k.

Some embodiments are based on the realization that in order to use the DDPMs to learn the visuomotor policies, one needs to change the output x to represent robot actions and make the denoising process conditioned on input observations Ot. Some embodiments are based on the realization that in diffusion policy formulation, an action sequence is rolled out for a certain horizon before replanning. Consequently, at time step t during execution, the diffusion policy takes the latest T_{O} steps of observation data Oₜ as input and predicts Tₚ steps of action, of which Tₐ steps of action are executed without re-planning. Thus, T_{O} is an observation horizon, Tₚ is a prediction horizon and Tₐ is an action execution horizon.

This is illustrated in FIG. 7 where a random action (assuming a dimension of action is Dₐ) over a length Tₐ 701 is drawn randomly and passed through a pre-trained diffusion model 704 (a conditional UNet Model). As a result, an action sequence 702 which is then passed to the robot 101. The robot 101 can then execute the action sequence 702 over the action execution horizon Tₐ to generate an observation sequence of length Tₐ 703. During training of the diffusion model 704, some embodiments can use an observation input 705 which can be passed through an image encoder 706 to generate a low-dimensional input 707 to the diffusion model 704.

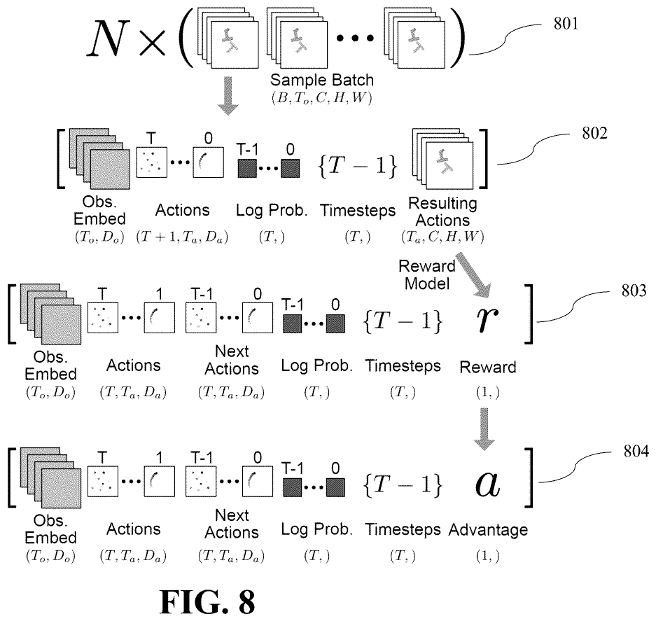

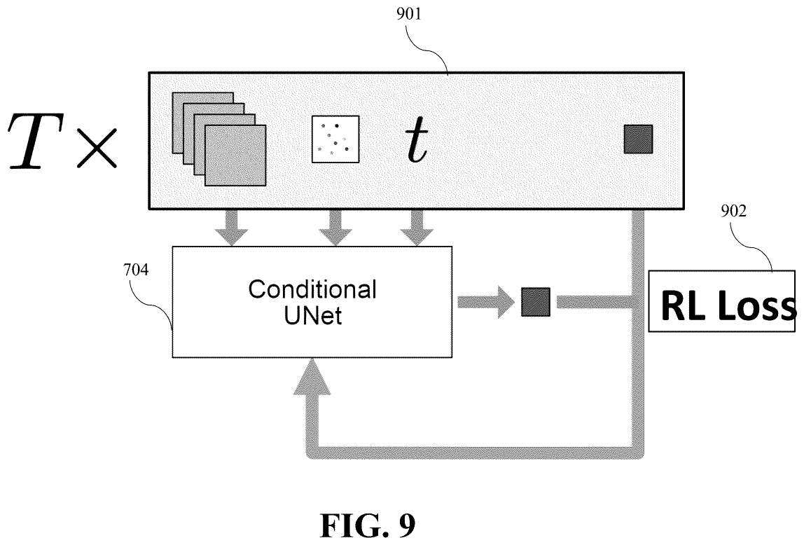

Some embodiments of the disclosure are based on the realization that in order to fine-tune the diffusion model using the reinforcement learning, the denoising process is to be formulated as the MDP which can be then optimized using policy gradients based on the reward function. FIG. 8 shows a formulation of the corresponding MDP for the diffusion policy as a T-step MDP. The formulation includes a dataset 801 that has been generated using the diffusion policy by running on the robot 101 which generates observations and actions 802 by rolling out the diffusion policy over T time-steps. The observations and actions 802 can be then used to compute a reward function shown in 803. This reward function can then be used to compute an advantage function 804. The advantage function 804 is then used to fine-tune the diffusion policy. FIG. 9 illustrates fine-tuning of the diffusion policy, according to an embodiment of the present disclosure. Rollouts 901 from the diffusion policy are used for computing a RL objective or loss function 902 which is used to update the diffusion model 704 (the conditional U-Net model).

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A controller for controlling an operation of a robot to execute a task, comprising: a processor; and a memory having instructions stored thereon that, when executed by the processor, cause the controller to:
collect a set of trajectories by executing a pre-trained diffusion policy of the robot;
receive a feedback label corresponding to each pair of trajectories of the set of trajectories, wherein the feedback label corresponding to each pair of trajectories indicates a preference to at least one trajectory of the corresponding pair of trajectories;
learn a reward function based on each pair of trajectories and its corresponding feedback label;
finetune the pre-trained diffusion policy based on the reward function, via reinforcement learning; and
control, based on the finetuned diffusion policy, the operation of the robot to execute the task.

2. The controller of claim 1, wherein each pair of trajectories of the set of trajectories is obtained by randomly sampling the set of trajectories.

3. The controller of claim 1, wherein each pair of trajectories includes a first trajectory and a second trajectory, and wherein the feedback label indicates one of:
a preference to the first trajectory;
a preference to the second trajectory; and
an equal preference to both the first trajectory and the second trajectory.

4. The controller of claim 1, wherein the feedback label is used to train a machine learning model that is configured to predict a scalar reward for a new trajectory.

5. The controller of claim 1, wherein an objective of the reinforcement learning is to maximize an expected cumulative reward over each trajectory.

6. The controller of claim 1, wherein, to finetune the pre-trained diffusion policy based on the reward function, the processor is further configured to maximize an objective function using reinforcement learning.

7. The controller of claim 6, wherein, to finetune the pre-trained diffusion policy based on the reward function, the processor is further configured to update parameters of the pre-trained diffusion policy in a direction of a gradient of the objective function.

8. The controller of claim 6, wherein the objective function includes a regularization term that is based on a Kullback-Leibler divergence between the finetuned control policy and the pre-trained diffusion policy.

9. The controller of claim 8, wherein the regularization term is assigned with a weight, and wherein the weight controls a fitting of the pre-trained diffusion policy to the reward function while preserving an ability of the pre-trained diffusion policy to perform an original task learned by the pre-trained diffusion policy.

10. The controller of claim 1, wherein the pre-trained diffusion policy models visuomotor robot policies using Denoising Diffusion Probabilistic Models (DDPMs).

11. The controller of claim 1, wherein the task includes one or a combination of pushing an object to a target location, stacking of objects, and aligning of the objects.

12. A method for controlling an operation of a robot to execute a task, comprising:
collecting a set of trajectories by executing a pre-trained diffusion policy of the robot;
receiving a feedback label corresponding to each pair of trajectories of the set of trajectories, wherein the feedback label corresponding to each pair of trajectories indicates a preference to at least one trajectory of the corresponding pair of trajectories;
learning a reward function based on each pair of trajectories and its corresponding feedback label;
finetuning the pre-trained diffusion policy based on the reward function, via reinforcement learning; and
controlling, based on the finetuned diffusion policy, the operation of the robot to execute the task.

13. The method of claim 12, wherein each pair of trajectories of the set of trajectories is obtained by randomly sampling the set of trajectories.

14. The method of claim 12, wherein each pair of trajectories includes a first trajectory and a second trajectory, and wherein the feedback label indicates one of:
a preference to the first trajectory;
a preference to the second trajectory; and
an equal preference to both the first trajectory and the second trajectory.

15. The method of claim 12, wherein an objective of the reinforcement learning is to maximize an expected cumulative reward over each trajectory of each pair of trajectories.

16. The method of claim 12, wherein, to finetune the pre-trained diffusion policy based on the reward function, the method further comprises maximizing an objective function using reinforcement learning.

17. The method of claim 16, wherein, to finetune the pre-trained diffusion policy based on the reward function, the method further comprises updating parameters of the pre-trained diffusion policy in a direction of a gradient of the objective function.

18. The method of claim 16, wherein the objective function includes a regularization term that is based on a Kullback-Leibler divergence between the finetuned control policy and the pre-trained diffusion policy.

19. The method of claim 18, wherein the regularization term is assigned with a weight, and wherein the weight controls a fitting of the pre-trained diffusion policy to the reward function while preserving an ability of the pre-trained diffusion policy to perform an original task learned by the pre-trained diffusion policy.

20. A non-transitory computer-readable storage medium embodied thereon a program executable by a processor for performing a method for controlling an operation of a robot to execute a task, the method comprising:
collecting a set of trajectories by executing a pre-trained diffusion policy of the robot;
receiving a feedback label corresponding to each pair of trajectories of the set of trajectories, wherein the feedback label corresponding to each pair of trajectories indicates a preference to at least one trajectory of the corresponding pair of trajectories;
learning a reward function based on each pair of trajectories and its corresponding feedback label;
finetuning the pre-trained diffusion policy based on the reward function, via reinforcement learning; and
controlling, based on the finetuned diffusion policy, the operation of the robot to execute the task.
